(19) United States
(12) Patent Application Publication
(10) Pub. No.: US 2022/0284460 A1
(43) Pub. Date: Sep. 8, 2022

(54) PRICE PREDICTION DEVICE

(71) Applicant: NTT DOCOMO, INC., Chiyoda-ku (JP)

(72) Inventors: Takumi OOSUGI, Chiyoda-ku (JP); Tsukasa DEMIZU, Chiyoda-ku (JP); Yusuke FUKAZAWA, Chiyoda-ku (JP)

(73) Assignee: NTT DOCOMO, INC., Chiyoda-ku (JP)

(21) Appl. No.: 17/638,068

(22) PCT Filed: Aug. 27, 2020
(86) PCT No.: PCT/JP2020/032412

§ 371 Date: Feb. 24, 2022

(30) Foreign Application Priority Data
Aug. 28, 2019 (JP) 2019-155845

(51) Int. Cl. G06Q 30/02

(52) U.S. Cl. CPC G06Q 30/0206; G06Q 30/0201

(57) ABSTRACT

A price prediction device includes an attribute acquisition unit that acquires data indicating attributes of consumers, a history acquisition unit that acquires data indicating a history of a product purchased by the consumer and a purchase price of the product, a probability acquisition unit that derives a selection probability of a target product being selected from a product group for each consumer based on the attribute and the history, and a derivation unit that derives an optimal price of the target product for each consumer based on the selection probability of the target product and a selling price of the target product, by using a price prediction model constructed by machine learning.

### TECHNICAL FIELD

The present disclosure relates to a price prediction device.

### BACKGROUND ART

Patent Literature 1 discloses a sales prediction device. This sales prediction device sets characteristics of all consumers and extracts one of the consumers whose characteristics have been set. The sales prediction device determines a preference of the extracted consumer, executes a price-oriented model when the preference of the consumer indicates price orientation, executes a model-oriented model when the preference of the consumer indicates model orientation, and executes a performance-oriented model when the preference of the consumer indicates performance orientation.

### CITATION LIST

### Patent Literature

### [Patent Literature 1] Japanese Unexamined Patent Publication No. 2008-299786

### SUMMARY OF INVENTION

### Technical Problem

In the sales prediction device of Patent Literature 1, the number of sales for each model is totaled after a simulation for all consumers whose characteristics have been set ends. In such technical field, it is required to predict the number of sales more accurately. For that purpose, for example, when an optimal price of a product for a consumer can be predicted, it is possible to predict the number of sales in an arbitrary price setting more accurately. The optimal price is a price at which a consumer can consider purchasing a product.

One aspect of this disclosure is to provide a price prediction device capable of predicting a number of sold products.

### Solution to Problem

A price prediction device according to an aspect of the present disclosure includes an attribute acquisition unit configured to acquire data indicating attributes of consumers; a history acquisition unit configured to acquire data indicating a history of a product purchased by a consumer and a purchase price of the product; a probability acquisition unit configured to derive a selection probability of a target product being selected from a product group for each consumer on the basis of the attribute and the history; and a derivation unit configured to derive an optimal price of the target product for each consumer on the basis of the selection probability of the target product and a selling price of the target product, by using a price prediction model constructed by machine learning.

In this price prediction device, the optimal price of the target product is derived by the price prediction model. In this model, the optimal price for each consumer is derived on the basis of the selling price of the target product and the selection probability of the target product derived for each consumer. Therefore, it is possible to predict the number of sold target products when an arbitrary price is set.

### Advantageous Effects of Invention

According to the price prediction device according to one aspect of the present disclosure, it is possible to predict the number of sold products.

### BRIEF DESCRIPTION OF DRAWINGS

FIG. 1 is a conceptual diagram illustrating a price prediction system including a price prediction device of an example.

FIG. 2 is a diagram for explaining an example of a product.

FIG. 3 is a conceptual diagram for explaining an example of a method of predicting a product selection probability.

FIG. 4 is a conceptual diagram for explaining an example of a loss function in a price prediction model.

FIG. 5 is a graph showing an example of a relationship between a predicted price and the number of sold products.

FIG. 6 is a flowchart illustrating an example of processing of a price prediction device.

FIG. 7 is a diagram illustrating a hardware configuration in the price prediction device of an example.

### DESCRIPTION OF EMBODIMENTS

Hereinafter, exemplary embodiments according to the present disclosure will be specifically described with reference to the drawings. For convenience, substantially the same elements may be denoted by the same reference signs and description thereof may be omitted.

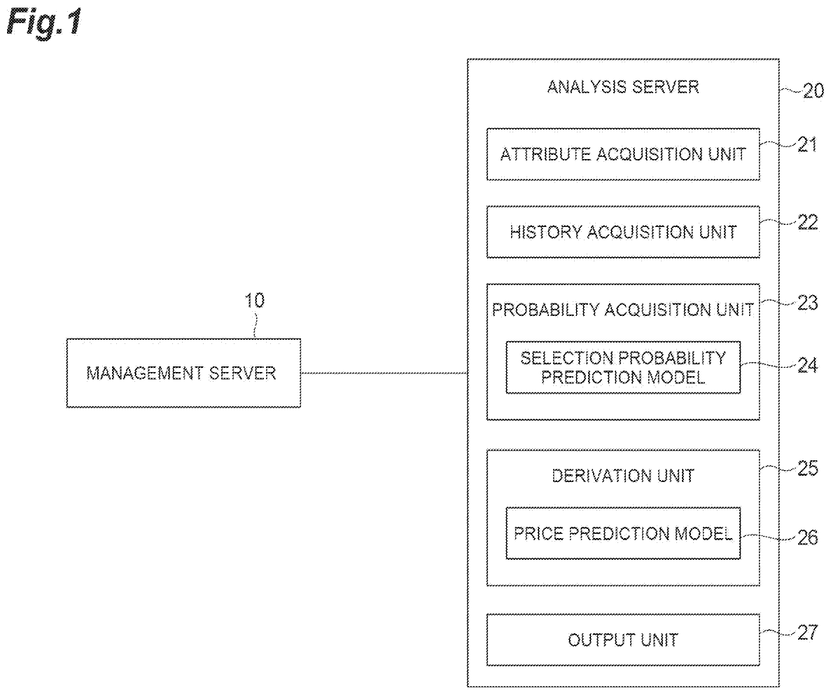

FIG. 1 is a conceptual diagram of an example of a price prediction system. A price prediction system 1 includes a management server 10 and an analysis server (price prediction device) 20. The management server 10 and the analysis server 20 are communicatively connected to each other. The price prediction system 1 predicts the optimal price for each consumer for any product (target product) in a product group. One example of the product is so-called durable consumer goods. That is, the product can be replaced by a consumer in a replacement cycle assumed according to durability of the product. Further, products constituting the product group may be replaced in a certain life cycle. For example, the product group illustrated in FIG. 1 includes products that can currently be purchased by consumers. As such durable consumer goods, for example, electric appliances, furniture, automobiles, and the like are assumed.

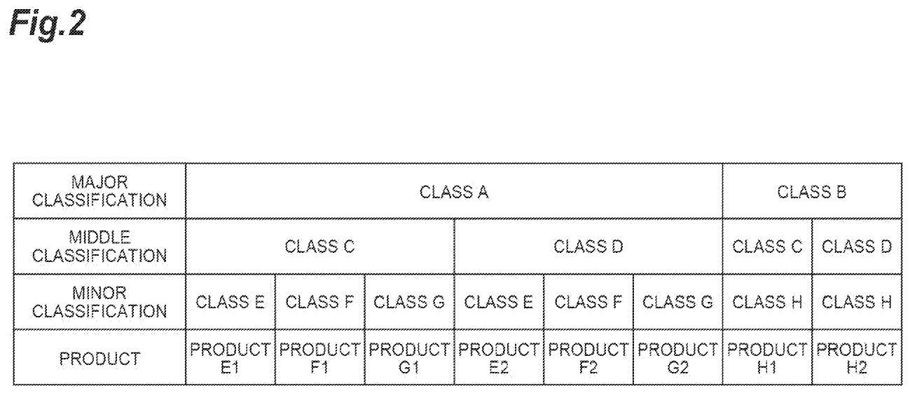

FIG. 2 is a diagram for explaining an example of the product. As illustrated in FIG. 2, an example product group includes a plurality of products E1, E1, F1, F2, G1, G2, H1, and H2 that compete with each other. The product group can be classified into a plurality of categories from different viewpoints. In the illustrated example, products are classified according to a major classification, a middle classification, and a minor classification. In the major classification, the middle classification, and the minor classification, the number of classes constituting each of the classifications is smaller than the number of types of products.

The major classification, the middle classification, and the minor classification, which are classifications for classifying product groups, are based on, for example, information on products that consumers refer to when selecting products. For example, the major classification, the middle classification, and the minor classification may be structural characteristics of products, functional characteristics of products, manufacturers of products, and the like. As an example, when a product is an electric appliance, a performance, a manufacturer, and the like can be classified.

The management server 10 includes a database that stores data indicating attributes of consumers (attribute data) and data indicating a history of a product purchased by a consumer and a purchase price of the product (history data). The attribute data of the consumers may include data indicating characteristics, properties, and the like that the respective consumers have regardless of products. In one example, the attribute data includes data indicating a user ID for identifying a consumer, and information on personal attributes such as a sex of the consumer, an age of the consumer, a family structure of the consumer, and a workplace of the consumer associated with the user ID.

Further, the attribute data may include service usage tendency information of the consumer. The service usage tendency information is, for example, information indicating a usage tendency of a service related to a product. As an example, the service usage tendency information may be data indicating a usage tendency of a consumer for various services that are provided by a manufacturer, seller, or the like of a product in relation to the product. The usage tendency may be, for example, a type, a number, and a frequency of use of a service being used. The service usage tendency information is information indicating a service that each consumer prefers, and may reflect the preference of each consumer.

The history data may be purchase data including a purchase history of a product by a consumer. The purchase data includes information for specifying the product, a purchase date and time of the product, a selling price of the product at the time of purchase, selling prices of other products at the time of purchase, and the like. Further, the history data includes not only purchase data related to a current product group, but also purchase data related to a product group released in the past.

The management server 10 is realized by, for example, a server device. Further, the management server 10 may be realized by a plurality of server devices, that is, a computer system. The management server 10 has a communication function and can perform transmission and reception of data to and from another device.

The analysis server 20 derives a selection probability that the consumer will select a specific product from the product group when the consumer purchases the product on the basis of the attribute data and the history data. The analysis server 20 derives the optimal price for the product for each consumer on the basis of the selection probability for the product and the selling price of the product by using a price prediction model constructed by machine learning.

The analysis server 20 is realized by, for example, a server device. Further, the analysis server 20 may be realized by a plurality of server devices, that is, a computer system. The analysis server 20 has a communication function and can perform transmission and reception of data to and from other devices.

The example analysis server 20 includes an attribute acquisition unit 21, a history acquisition unit 22, a probability acquisition unit 23, a derivation unit 25, and an output unit 27. The attribute acquisition unit 21 acquires the attribute data of the consumer from the management server 100. Further, the history acquisition unit 22 acquires the history data from the management server 10. In the analysis server 20, the acquired attribute data and history data can be stored in association with each other for each user ID.

The probability acquisition unit 23 derives the selection probability that the consumer will select an arbitrary product from the product group on the basis of the attribute data and the history data. The probability acquisition unit 23 of one example has a selection probability prediction model 24 constructed by machine learning. The probability acquisition unit 23 derives the product selection probability for each consumer by using the selection probability prediction model 24. The selection probability prediction model 24 can be constructed in the probability acquisition unit 23.

The probability acquisition unit 23 uses learning data (training data) with the attribute data and the history data as explanatory variables and data of products actually purchased by consumers as an objective function to construct the selection probability prediction model 24 using a machine learning scheme. Examples of an algorithm to be used for a machine learning model may include logistic regression, a k-nearest neighbor method, a support vector machine, random forest, gradient boosting, and a deep neural network.

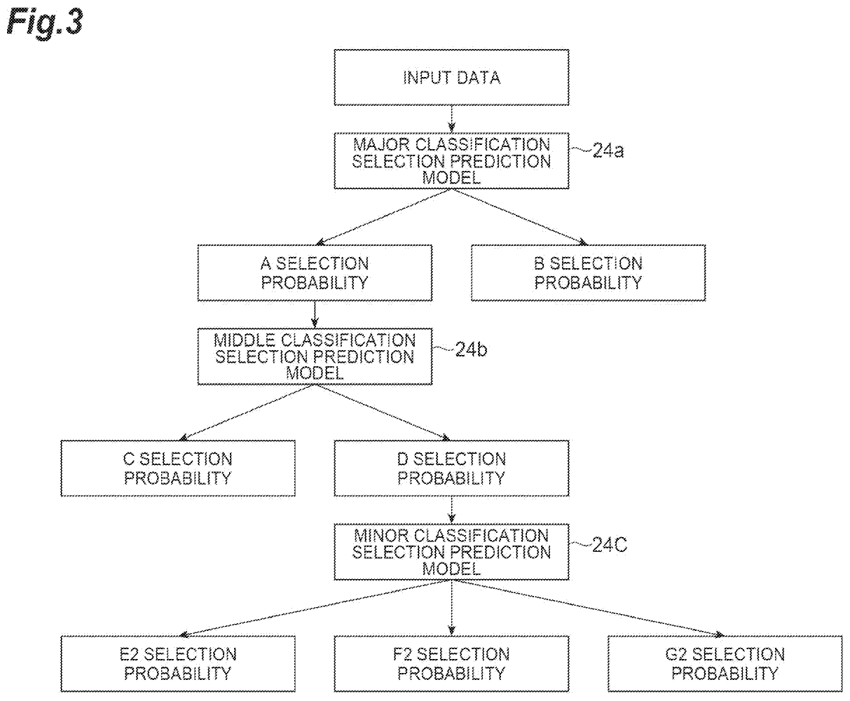

In the probability acquisition unit 23 of one example, a plurality of prediction models according to a classification of the product group are constructed. FIG. 3 is a conceptual diagram for explaining an example of a method of predicting a product selection probability. In FIG. 3, an example in which the selection probability for products E2, F2, and G2 is predicted is illustrated. As illustrated in FIG. 3, the selection probability prediction model 24 of an example includes a major classification selection prediction model 24a, a middle classification selection prediction model 24b, and a minor classification selection prediction model 24c.

The major classification selection prediction model 24a is a learning model for predicting whether the consumer will select class A or class B from the major classifications for classifying the product groups. The major classification selection prediction model 24a can be constructed by using learning data with the attribute data and the history data as the explanatory variables and a class of the major classification to which the actually purchased product belongs as an objective function.

The middle classification selection prediction model 24b is a learning model for predicting whether the consumer will select class C or class D from the middle classifications for classifying the product groups. The middle classification selection prediction model 24b can be constructed by using learning data with the attribute data and the history data as explanatory variables and a class of the middle classification to which the actually purchased product belongs as the objective function.

The minor classification selection prediction model 24c is a model for predicting whether the consumer will select class E, class F, class G, or class H from the minor classification for classifying the product groups. The minor classification selection prediction model 24c can be constructed by using learning data with the attribute data and the history data as explanatory variables and a class of the minor classification to which the actually purchased product belongs as the objective function. When selection probabilities of products E2, F2, and G2 are predicted as in the example of FIG. 3, there is no product corresponding to class H, and thus class H may be excluded from the minor classification selection prediction model 24c.

In the probability acquisition unit 23 of one example, the product selection probability by the consumer is calculated step by step for each classification on the basis of the major classification selection prediction model 24a, the middle classification selection prediction model 24b, and the minor classification selection prediction model 24c. That is, for example, when the selection probability for the product E2 is obtained as illustrated in FIG. 3, input data is first input to the major classification selection prediction model 24a to derive a selection probability for class A. Subsequently, the input data is input to the middle classification selection prediction model 24b to derive a selection probability for class D. The input data is input to the minor classification selection prediction model 24c to derive a selection probability of class E. The selection probability for the product E2 can be derived by multiplying the selection probabilities derived by the respective learning models.

The attribute data and the history data used for construction of the respective models may be configured not to overlap each other so that a correlation among the major classification selection prediction model 24a, the middle classification selection prediction model 24b, and the minor classification selection prediction model 24c does not become large.

The derivation unit 25 derives the optimal price of the target product for each consumer on the basis of the product selection probability and the selling price of the product. The derivation unit 25 of one example includes a price prediction model 26 constructed by machine learning, and uses this price prediction model 26 to derive the optimal price of the product for each consumer. The price prediction model 26 is constructed in the derivation unit 25. For example, the derivation unit 25 constructs the price prediction model 26 for each product that is a price prediction target.

The price prediction model 26 is constructed by machine learning so that a product selection probability by each consumer, a product price of a product at the time of product purchase, and the presence or absence of product purchase by each consumer are input data, and an optimal price for each consumer is output data. The product price is a purchase price of the target product by the consumer in a case in which the consumer has purchased the target product, and is a selling price of the target product at a point in time when the consumer has purchased another product competing with the target product in a case in which the consumer does not purchase the target product. In a case in which the consumer purchases neither the target product nor the other competing product, data for the consumer is not used to construct the price prediction model. That is, the price prediction model is constructed on the basis of data of a consumer who has purchased the target product or the other competing product. Examples of an algorithm to be used for a machine learning model may include linear regression, a k-nearest neighbor method, a support vector machine, random forest, gradient boosting, and a deep neural network.

The price prediction model 26 of an example predicts a price that is neither too high nor too low for each consumer as the optimal price. For example, in a case in which the target product is purchased by the consumer, the consumer may have purchased the product even though the price was higher than the purchase price. Further, in a case in which the target product has not been purchased by the consumer, the consumer may have purchased the product when the price was lower than the selling price. On the other hand, even in a case in which the target product is purchased by the consumer, the consumer may not have purchased the product when the price had been higher than the purchase price. Further, in a case in which the target product is not purchased by the consumer, the consumer may have purchased the product when the price had been lower than the selling price, but when the selling price is too low, profits of a seller may be reduced. Therefore, the optimal price of one example may be an appropriate price (price range) that does not reduce profits of a seller among prices at which consumers can purchase.

However, there is no correct answer data indicating the optimal price for each consumer. Therefore, the price prediction model 26 is constructed so that an optimal price for minimizing a value of a loss function, which is designed so that a loss becomes large when a predicted price not suitable as the optimal price is derived, is output by using the loss function.

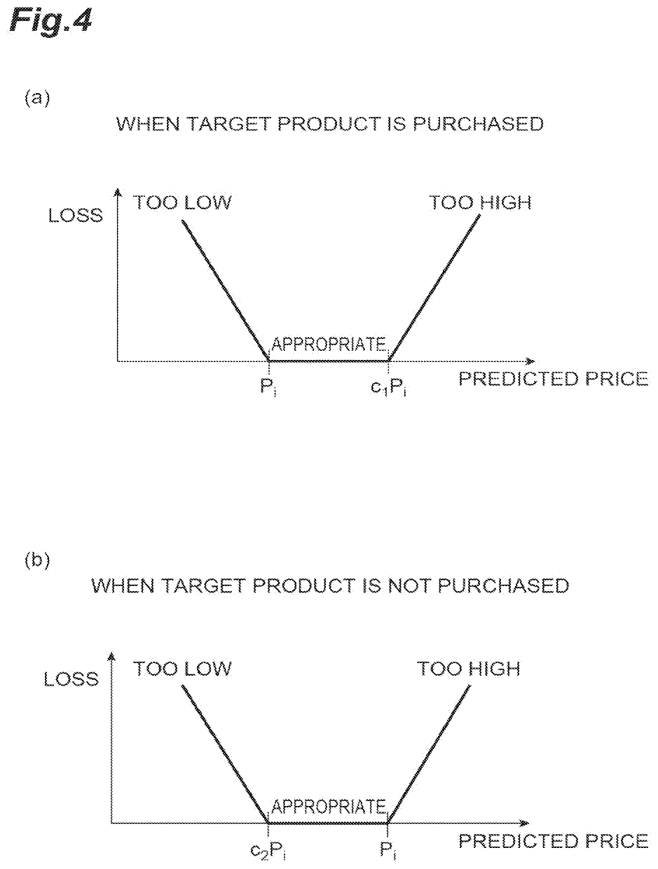

FIG. 4 is a conceptual diagram for explaining an example of the loss function in the price prediction model. (a) of FIG. 4 illustrates an example of a loss function when the consumer purchases the target product, and (b) of FIG. 4 illustrates an example of the loss function in a case in which the consumer does not purchase the target product, which is a case in which another product competing with the target product is purchased.

As illustrated in (a) of FIG. 4, when a price lower than a product price Pᵢ is derived as the optimal price in a case in which the consumer purchases the target product, the price is not suitable as the optimal price, and a loss becomes large in the loss function. Further, in the loss function, the loss becomes zero when a price higher than the product price Pi in a range considered to be appropriate is derived as a predicted price. In one example, a coefficient C₁ defining an upper limit price C₁Pᵢ considered to be appropriate is a value shown in 1<C₁ and may be set by, for example, a manager of the analysis server 20. Further, in the loss function, when a price higher than the upper limit price C₁Pᵢ is derived as the optimal price, the loss becomes large because the price is too high.

As illustrated in (b) of FIG. 4, when a price higher than a product price Pᵢ is derived as the optimal price in a case in which the consumer does not purchase the target product, the price is not suitable as the optimal price, and the loss becomes large in the loss function. Further, in the loss function, the loss becomes zero when a price lower than the product price Pᵢ in a range considered to be appropriate is derived as a predicted price. In one example, a coefficient C₂ defining a lower limit price C₂Pᵢ considered to be appropriate is a value shown in 0<C₂<1 and may be set by, for example, the manager of the analysis server 20. Further, in the loss function, when a price lower than the lower limit price C₂Pᵢ is derived as the optimal price, the loss becomes large because the price is too low.

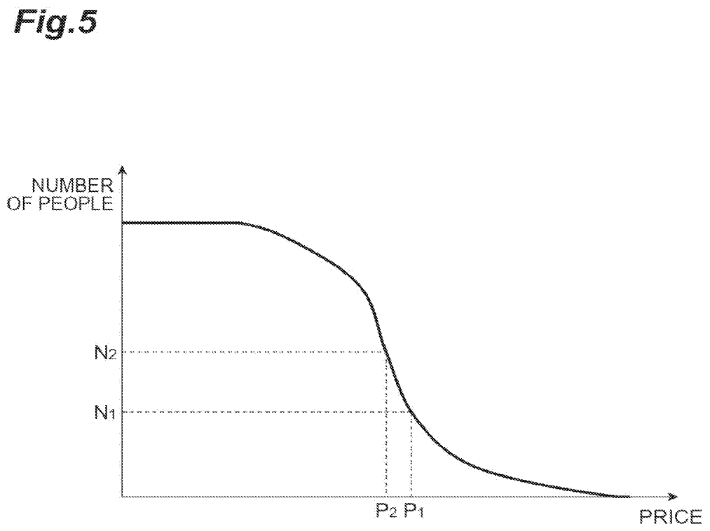

The output unit 27 outputs a relationship between the price and the number of sold target products on the basis of the optimal price for all consumers derived by the derivation unit 25. FIG. 5 is a graph showing an example of a relationship between the predicted price and the number of sold products, which is output by the output unit 27. In FIG. 5, a graph with the price as a horizontal axis and a cumulative number of consumers from which an optimal price equal to or higher than the price on the horizontal axis has been derived as a vertical axis is shown. The number of consumers for which a value equal to or higher than a price P₁ is derived as the optimal price is N₁. The number of consumers for which a value equal to or higher than a price P₂ is derived as the optimal price is N₂. In this case, for example, when the price of the product is reduced from the current price P₁ to the price P₂, the number of products corresponding to N₂−N₁ is expected to be sold.

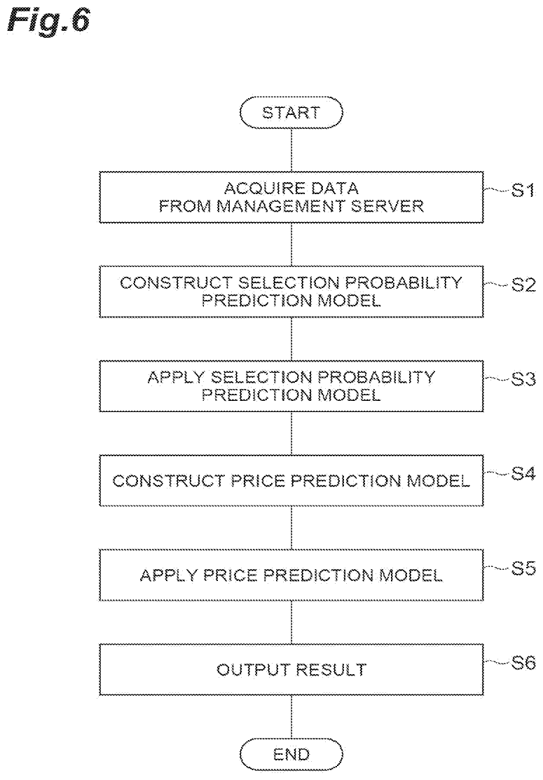

Next, an operation of the price prediction system will be explained. FIG. 6 is a flowchart illustrating an example of processing of the price prediction system. As an example, a case in which the optimal price of the product E2 is predicted will be described.

As illustrated in FIG. 6, in the price prediction system 1, first, the attribute acquisition unit 21 and the history acquisition unit 22 of the analysis server 20 acquire the attribute data and the history data of all consumers from the management server 10 (step S1). Subsequently, the probability acquisition unit 23 constructs the selection probability prediction model 24 (step S2). When the optimal price for the product E2 is predicted, at least the selection probability prediction model 24 for the product E2 is constructed. The selection probability for the product E2 is derived for each consumer by the probability acquisition unit 23 to which the constructed selection probability prediction model 24 has been applied (step S3).

Subsequently, the price prediction model 26 for the product E2 is constructed in the derivation unit 25 (step S4). The optimal price of the product E2 is derived for each consumer by the derivation unit 25 to which the constructed price prediction model 26 has been applied (step S5). In step S3, the optimal price may be derived for all consumers, or the optimal price may be derived only for consumers who have not purchased the products constituting the product group.

Subsequently, a graph showing a relationship between the price and the number of people (number of sales) is output as a result on the basis of the optimal price derived in step S5 (step S6). When the optimal price for all consumers is derived in step S5, the graph may be constructed on the basis of the optimal price for all consumers. Further, when the optimal price is derived only for the consumers who have not purchased the products constituting the product group in step S5, actual purchase prices for consumers who have purchased the product E2 may be reflected to construct the graph. That is, the graph may be constructed with the number of consumers who have purchased the product E2 as an actually measured value and the number of consumers who have not purchased the product as a predicted value.

In the analysis server 20 described above, the optimal price of the target product is derived by the price prediction model 26. In this model, the optimal price for each consumer is derived on the basis of the selling price of the target product and the selection probability of the target product derived for each consumer. Therefore, by accumulating prediction results for respective consumers, it is possible to predict the number of sold target products when an arbitrary price is set. In this case, it is possible to predict a demand when a current selling price is reduced.

Further, the price prediction model is constructed by machine learning so that the selection probability for the product by the consumer, the product price of the target product, and the presence or absence of the purchase of the target product by the consumer are input data, and the optimal price is output data. In this case, the product price is the purchase price of the target product by the consumer when the consumer purchases the target product, and is the selling price of the target product at a point in time when the consumer has purchased another product competing with the target product when the consumer does not purchase the target product. According to this configuration, it is possible to supplement a product price for consumers who do not purchase a product of which the price is to be predicted. When such supplementing is not performed, the input data is constructed only by attribute data and history data of the consumers who have purchased the products, and therefore the input data is biased. Supplementing the product price can curb biasing of the input data.

Further, in the price prediction model, an optimal price is output so that a value of the loss function is minimized. In the loss function, in a case in which the consumer purchases the target product, the loss becomes large when a price lower than the product price is derived as the optimal price, and in a case in which the consumer does not purchase the target product, the loss becomes large when a price higher than the product price is derived as the optimal price. According to this configuration, loss functions suitable for a consumer who is likely to purchase the product and a consumer who is unlikely to purchase the product can be applied to the respective consumers. Therefore, it is possible to predict the optimal price according to attributes of each consumer.

Further, since the analysis server 20 includes the output unit 27 that outputs the relationship between the product price and the number of sold products, it is possible to visualize and output the number of sold target products when an arbitrary price is set.

In the price prediction system 1 described above, for example, the price prediction model 26 may include a selling price of another product competing with the target product as the input data. When a consumer actually considers purchasing a product, a price difference between the products constituting the product group may be one of materials to be considered. According to the above configuration, since information on a selling price of another product competing with a product for which the price is to be predicted is reflected in the price prediction model 26, the accuracy of the price prediction can be improved.

Further, for example, the price prediction model 26 may include a probability that the consumer will select another product as the input data. In this case, the probability acquisition unit 23 derives the selection probabilities for all the products constituting the product group. Since not only a selection probability for the product that is a price prediction target but also a selection probability of competing products is taken into consideration, the accuracy of price prediction can be improved.

Further, although an example in which the price of the product used as the input data at the time of constructing the price prediction model 26 is predicted in the analysis server 20 of one example has been shown, for example, the analysis server 20 may predict a price of a successor product of the product used as the input data at the time of constructing the price prediction model 26. For example, using the constructed price prediction model 26, it is possible to execute the prediction of the price of the successor product by using an assumed price of the successor product, an assumed price of a product assumed as a product competing with the successor product, and the like as input data. The successor product is a new product manufactured by the same manufacturer as that for an old product, and is a new product having the same target layer as that of the old product because the successor product has the same performance as the old product. Therefore, regarding the old product and the new product as the same product makes it possible to use a learning model constructed on the basis of sales data of the old product for prediction of the price of the new product.

The block diagrams used in the description of the embodiment show blocks in units of functions. These functional blocks (components) are realized in any combination of at least one of hardware and software. Further, a method of realizing each functional block is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but the present disclosure is not limited thereto. For example, a functional block (a component) that functions for transmission is referred to as a transmitting unit or a transmitter. In any case, a realizing method is not particularly limited, as described above.

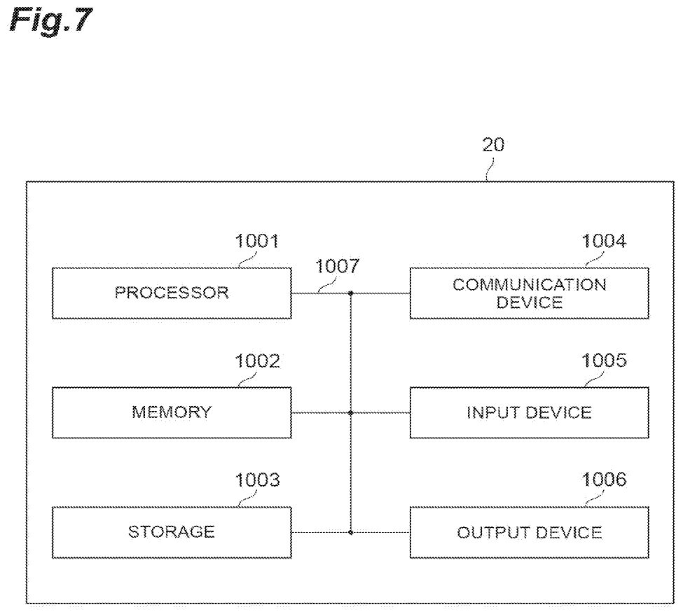

For example, the analysis server 20 in an embodiment of the present disclosure may function as a computer that performs information processing of the present disclosure. FIG. 7 is a diagram illustrating an example of a hardware configuration of the analysis server 20 according to the embodiment of the present disclosure. The analysis server 20 described above may be physically configured as a computer device including a processor 1001, a memory 1002, a storage 1003, a communication device 1004, an input device 1005, an output device 1006, a bus 1007, and the like.

In the following description, the term “device” can be read as a circuit, a device, a unit, or the like. The hardware configuration of the analysis server 20 may be configured to include one or a plurality of illustrated devices, or may be configured without including some of the devices.

Each function in the analysis server 20 is realized by loading predetermined software (a program) into hardware such as the processor 1001 or the memory 1002 so that the processor 1001 performs calculation to control communication that is performed by the communication device 1004 or control at least one of reading and writing of data in the memory 1002 and the storage 1003.

The processor 1001, for example, operates an operating system to control the entire computer. The processor 1001 may be configured of a central processing unit (CPU) including an interface with a peripheral device, a control device, a calculation device, a register, and the like. For example, the attribute acquisition unit 21, the history acquisition unit 22, the probability acquisition unit 23, the derivation unit 25, and the output unit 27 in the above-described analysis server 20 may be realized by the processor 1001.

Further, the processor 1001 reads a program (program code), a software module, or data from at least one of the storage 1003 and the communication device 1004 into the memory 1002 and executes various processes according to the program, the software module, or the data. As the program, a program for causing the computer to execute at least some of the operations described in the above embodiment may be used. For example, the analysis server 20 may be realized by a control program stored in the memory 1002 and operating in the processor 1001. Although the case in which the various processes described above are executed by one processor 1001 has been described, the processes may be executed simultaneously or sequentially by two or more processors 1001. The processor 1001 may be implemented by one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store a program (program code), a software module, or the like that can be executed to perform information processing according to an embodiment of the present disclosure.

The storage 1003 is a computer-readable recording medium and may be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. A storage medium included in the analysis server 20 may be, for example, a database including at least one of the memory 1002 and the storage 1003, a server, or any other appropriate medium.

The communication device 1004 is hardware (a transmission and reception device) for performing communication between computers via at least one of a wired network and a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, each device such as the processor 1001 and the memory 1002 is connected by the bus 1007 for communicating information. The bus 1007 may be configured by using a single bus, or may be configured by using a different bus for each device.

Further, the analysis server 20 may include hardware such as a microprocessor, a digital signal processor (DSP), an application specific integrated circuit (ASIC), a programmable logic device (PLD), and a field programmable gate array (FPGA), and some or all of respective functional blocks may be realized by the hardware. For example, the processor 1001 may be implemented using at least one of these pieces of hardware.

A process procedure, a sequence, a flowchart, and the like in each aspect/embodiment described in the present disclosure may be in a different order unless inconsistency arises. For example, for the method described in the present disclosure, elements of various steps are presented in an exemplary order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to being made explicitly, and may be made implicitly (for example, a notification of the predetermined information is not made).

Although the present disclosure has been described above in detail, it is obvious to those skilled in the art that the present disclosure is not limited to the embodiments described in the present disclosure. The present disclosure can be implemented as modified and changed aspects without departing from the spirit and scope of the present disclosure defined by the description of the claims. Therefore, the description of the present disclosure is intended for exemplification, and does not have any restrictive meaning with respect to the present disclosure.

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless of whether the software may be called software, firmware, middleware, microcode, or hardware description language or called another name.

Further, software, instructions, information, and the like may be transmitted and received via a transmission medium. For example, when software is transmitted from a website, a server, or another remote source using at least one of a wired technology (a coaxial cable, an optical fiber cable, a twisted pair, a digital subscriber line (DSL), and the like) and a wireless technology (infrared rays, microwaves, and the like), the at least one of the wired technology and the wireless technology is included in the definition of the transmission medium.

The terms “system” and “network” used in the present disclosure are used interchangeably.

Further, information, parameters, and the like described in the present disclosure may be represented by an absolute value, may be represented by a relative value from a predetermined value, or may be represented by corresponding different information.

At least one of the server and the client may be called a transmission device, a reception device, a communication device, or the like. At least one of the server and the client may be a device mounted on a mobile body, the mobile body itself, or the like. The moving body may be a vehicle (for example, a car or an airplane), may be an unmanned moving body (for example, a drone or an autonomous vehicle), or may be a robot (manned or unmanned type). At least one of the server and the client includes a device that does not necessarily move at the time of a communication operation. For example, at least one of the server and the client may be an Internet of Things (IoT) device such as a sensor.

Further, the server in the present disclosure may be read as a client terminal. For example, each aspect or embodiment of the present disclosure may be applied to a configuration in which communication between the server and the client terminal is replaced with communication between a plurality of user terminals (which may be called, for example, device-to-device (D2D) or vehicle-to-everything (V2X)). In this case, the client terminal may have a function of the above-described server.

Similarly, the client terminal in the present disclosure may be read as the server. In this case, the server may have functions of the above-described client terminal.

The term “determining” used in the present disclosure may include a variety of operations. The “determining” can include, for example, regarding judging, calculating, computing, processing, deriving, investigating, searching (looking up or inquiry) (for example, looking up in a table, a database or another data structure), or ascertaining as “determining”. Further, “determining” can include, for example, regarding receiving (for example, receiving information), transmitting (for example, transmitting information), inputting, outputting, or accessing (for example, accessing data in a memory) as “determining”. Further, “determining” can include regarding resolving, selecting, choosing, establishing, comparing or the like as “determining”. That is, “determining” can include regarding a certain operation as “determining”. Further, “determining” may be read as “assuming”, “expecting”, “considering”, or the like.

The terms “connected”, “coupled”, or any modification thereof means any direct or indirect connection or coupling between two or more elements, and can include the presence of one or more intermediate elements between two elements “connected” or “coupled” to each other. The coupling or connection between elements may be physical, may be logical, or may be a combination thereof. For example, “connection” may be read as “access.” When used in the present disclosure, two elements can be considered to be “connected” or “coupled” to each other by using at least one of one or more wires, cables, and printed electrical connections, and by using electromagnetic energy having wavelengths in a radio frequency region, a microwave region, and a light (both visible and invisible) region as some non-limiting and non-comprehensive examples.

The description “based on” used in the present disclosure does not mean “based only on” unless otherwise noted. In other words, the description “based on” means both of “based only on” and “at least based on”.

Any reference to elements using designations such as “first” and “second” as used in the present disclosure does not generally limit an amount or order of those elements. These designations can be used in the present disclosure as a convenient way to distinguish between two or more elements. Thus, the reference to the first and second elements does not mean that only two elements can be adopted or that the first element has to precede the second element in some way.

When “include”, “including” and variations thereof are used in the present disclosure, those terms are intended to be comprehensive like the term “comprising”. Further, the term “or” used in the present disclosure is intended not to be an exclusive OR.

In the present disclosure, for example, when an article such as a, an, and the in English is added by translation, the present disclosure may include that a noun following such an article is plural.

In the present disclosure, a sentence “A and B differ” may mean that “A and B are different from each other.” The sentence may mean that “each of A and B is different from C.” Terms such as “separate”, “coupled”, and the like may also be interpreted, similar to “different.”

### REFERENCE SIGNS LIST

20: Analysis server (price prediction device)
21: Attribute acquisition unit
22: History acquisition unit
23: Probability acquisition unit
25: Derivation unit
26: Price prediction model
27: Output unit

1. A price prediction device comprising:
an attribute acquisition unit configured to acquire data indicating attributes of consumers;
a history acquisition unit configured to acquire data indicating a history of a product purchased by a consumer and a purchase price of the product;
a probability acquisition unit configured to derive a selection probability of a target product being selected from a product group for each consumer based on the attribute and the history; and
a derivation unit configured to derive an optimal price of the target product for each consumer based on the selection probability of the target product and a selling price of the target product, by using a price prediction model constructed by machine learning.

2. The price prediction device according to claim 1,
wherein the price prediction model is constructed by machine learning so that the selection probability of the target product by the consumer, a product price of the target product, and a presence or absence of purchase of the target product by the consumer are input data, and the optimal price is output data,
the product price
is a purchase price of the target product by the consumer when the consumer purchases the target product, and
is the selling price of the target product at a point in time when the consumer has purchased another product competing with the target product when the consumer does not purchase the target product.

3. The price prediction device according to claim 2,
wherein, in the price prediction model, the optimal price is output so that a value of a loss function is minimized, and
in the loss function,
in a case in which the consumer purchases the target product, a loss becomes large when a price lower than the product price is derived as the optimal price, and
in a case in which the consumer does not purchase the target product, the loss becomes large when a price higher than the product price is derived as the optimal price.

4. The price prediction device according to claim 2, wherein the price prediction model includes a selling price of another product competing with the target product as the input data.

5. The price prediction device according to claim 2, wherein the price prediction model includes a selection probability for each consumer of another product competing with the target product as the input data.

6. The price prediction device according to claim 1, further comprising an output unit configured to output a relationship between the price and the number of sales in the target product based on the optimal price for each of a plurality of consumers derived by the derivation unit.
